(19) United States
(12) Patent Application Publication
(10) Pub. No.: US 2016/0259811 A1
(43) Pub. Date: Sep. 8, 2016

(54) METHOD AND SYSTEM FOR METADATA SYNCHRONIZATION

(71) Applicants: Andrew E.S. MacKay, Carp (CA); Kyle Fransham, Ottawa (CA)

(72) Inventors: Andrew E.S. MacKay, Carp (CA); Kyle Fransham, Ottawa (CA)

(73) Assignee: Superna Business Consulting, Inc., Kanata (CA)

(21) Appl. No.: 15/062,426

(22) Filed: Mar. 7, 2016

Related U.S. Application Data
(60) Provisional application No. 62/129,463, filed on Mar. 6, 2015.

(51) Int. Cl. G06F 17/30; H04L 29/08; G06F 21/62

(52) U.S. Cl. CPC G06F 17/30174; G06F 21/62; H04L 67/1095

(57) ABSTRACT

The present disclosure provides a method for providing transparent configuration metadata for file access and security between replicated copies of data using dissimilar protocols and technologies to store share and access file based data in a hybrid cloud architecture.

### CROSS-RELATED APPLICATIONS

The present application claims priority to U.S. Provisional Patent Application 62/129,463 titled “Geographic Network Attached and Cloud Based Storage Metadata Configuration Synchronization” filed Mar. 6, 2015, which is hereby incorporated by reference in its entirety.

### FIELD

The present disclosure pertains to the field of file based storage. Specifically, the present disclosure relates to methods and systems for replicating data for disaster recovery, distribution caching for localized access geographically and conversion from file-based to object-based cloud storage.

### BACKGROUND

File based storage has grown at a double digit rate for many years. The proliferation of various devices generating digital data, including the IOT (internet of things) along with smart meters and surveillance video, has driven this growth rate of files and storage products traditionally called network attached storage arrays or NAS devices.

NAS devices speak two common languages for client's machines to access files, namely nfs (network file system) and SMB (server message block) protocols. These protocols have a security model for role based or user based access permissions to files along with many configuration parameters that determine how files can be assessed. This configuration data is typically called “share configuration data” in the SMB protocol and “export configuration data” in the nfs protocol. The configuration data is concerned with security, authentication of users, passwords and host machines and rules or policies on how the data is accessed.

File-based storage has the ability to allow various paths in the file system tree to have file shares (or, alternatively, file exports) configured for access to the file of interest.

The growth rate of file storage requires the application of a growth management strategy, traditionally called quotas, which are policies on how to limit growth of files and the actions that should occur when these set limits are reached. This type of quota policy can be applied to various locations in the file system.

Replication of file based data has existed for many years and large copy tools have been developed for this specific purpose. The issue with these tools is that configuration and policy data is not stored in the file system and typically resides in the NAS device.

With the introduction of cloud services for remote data storage new options now exist to store data that treat files as objects without regard for the type of file that is stored and allow a variety of types of files, including text, powerpoint, image, audio or even binary format files to be stored with associated metadata that can describe both the object and the access permissions to that particular object.

Further, object-based data has a different method or protocol to access this type of data which is typically not compatible with traditional NAS devices, or the SMB and nfs protocols.

Therefore there is a need for a system and method for extracting the logical configuration metadata from NAS devices and cloud-based objects and translating the policy and metadata required to maintain consistent access to copies of this same metadata residing in NAS devices and cloud storage databases.

### BRIEF SUMMARY

In at least one embodiment, the present disclosure provides a system and method for extracting the logical configuration metadata from NAS devices and cloud-based object stores and translates the policy and metadata required to maintain consistent access to copies of the same metadata residing in either NAS devices or cloud storage. In one non-limiting example, cloud based object stores can include Amazon S3 and Google storage buckets.

In at least one embodiment, this translation function maps differences in the access protocol, security model access levels and permissions on the files between different systems that hold a copy of the data. In some embodiments, when possible, policies that protect (for example, file replication or copying) or limit access to the visibility, and growth rate of the data are preserved across access points. This can allow data to be accessed from multiple locations. Accordingly such a system can allow access both from geographically separate devices and using different access methods to manage security and access policies.

### BRIEF DESCRIPTION OF THE FIGURES

Embodiments of the present invention will be better understood in connection with the following Figures, in which:

FIG. 1 schematically illustrates a method according to an embodiment;

FIG. 2 schematically illustrates that such a system and method can be extended to include a plurality of enterprise file systems;

FIG. 3 schematically illustrates that the system for translating the metadata need not reside within the datapath of the data being replicated;

FIG. 4 illustrates one embodiment of the system implementation;

FIG. 5 schematically illustrates that the system can replicate data according to business rules translate the metadata as data is replicated onto a plurality of storage systems;

FIG. 6 illustrates another embodiment of the system implementation; and

FIG. 7 illustrates yet another embodiment of the system implementation.

### DETAILED DESCRIPTION OF THE EMBODIMENTS

The skilled person will appreciate that in a number of embodiments the present disclosure can provide a system capable of bridging the differences between file based storage systems both inside an Enterprise and Internet cloud based storage systems.

In some embodiments, the present disclosure can provide a system capable of distributing copies of data for the purposes of Disaster recovery, caching, application mobility across geographically dispersed systems, or combinations thereof.

In some embodiments, the present disclosure can provide a system that operates on the metadata of the diverse storage systems without being in the data path between work stations or computers that are operating read and write operations against the data.

In some embodiments, the present disclosure can provide a system that enables distribution and synchronization of metadata independently of the storage system or platform while retaining access permissions, archive status, copy status, geographic location for Disaster recovery of file based data.

In some embodiments, the present disclosure provides a system of software components that enables real-time translation of metadata needed to ensure consistent access with security of the data maintained across dissimilar storage platforms.

The present disclosure also contemplates system that allows business logic that enables metadata consistency in geographically replicated data sets. Some embodiments include an Orchestration function allows the system to places files on remote systems by controlling copy functions in storage systems or cloud systems with an API (application programming Interface) using metadata rules to control how metadata is discovered and stored in the system.

In some embodiments, the present disclosure provides scaling and implementation that allows scaling of processing metadata to scale based on docker Container clusters.

In some embodiments, the present disclosure can provide metadata transparency that allows applications to access data using native protocols and methods without regard for the metadata required to allow the access to manipulate file based data.

The present disclosure also contemplates methods to allow data to be replicated based on workflows that ensure metadata needed to access the data in case of disaster is transparent and automatically synchronized independently of the data itself.

In some embodiments, the present disclosure can provide a storage access protocol independent system that can allow applications to access using a protocol native to the application while maintaining access permissions and other metadata attributes for the life cycle of the data.

In some embodiments, the present disclosure provides a system that can operate against storage devices regardless of location or metadata similarities in both function and security levels.

In some embodiments, the present disclosure provides a system capable of reporting on the location of data and it's metadata regardless of the geographic location and underlying storage platform, which can be translated in real time between dissimilar storage and access protocol methods including, for example, storage buckets or various file systems. Examples of file systems include NFS (Network File System) and SMB (Server Message Block).

In some embodiments, the present disclosure provides a system that allows requests for file metadata translation and execution of the request that enables a shared physical or virtual host model where all layers required to complete the request are co-resident.

In some embodiments, the present disclosure provides a system that allows requests for file metadata translation and execution of the request that enables a separate between the service layer running on the on premise location of an enterprise and the execution layer running in the cloud.

### Methodology Overview

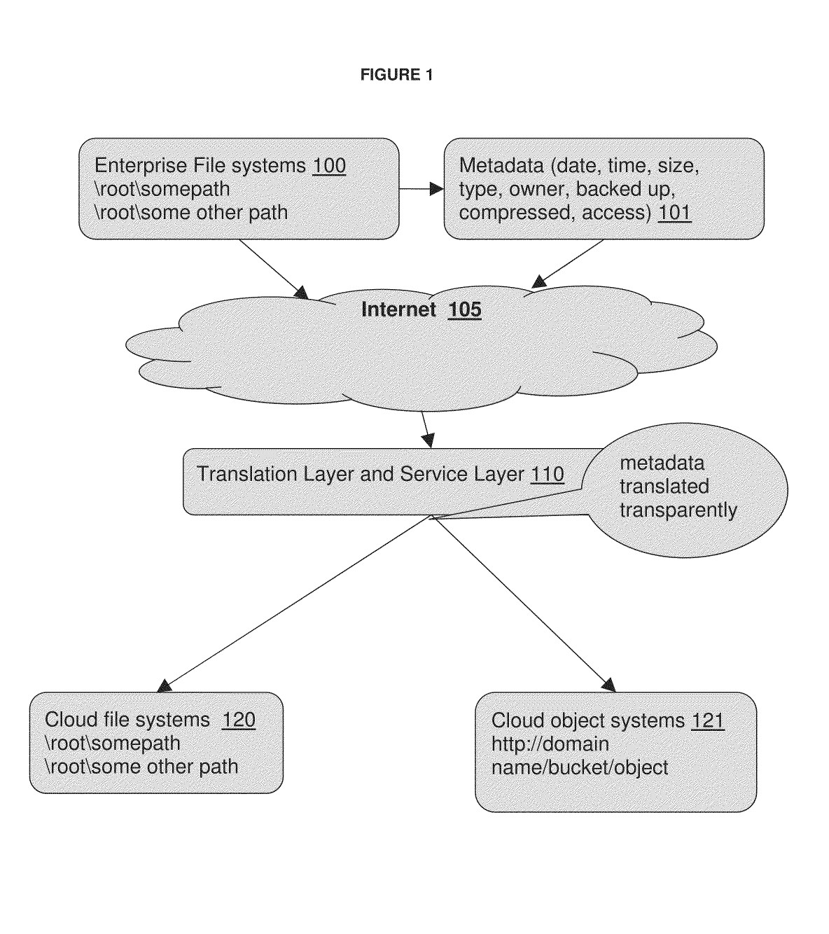

FIG. 1 schematically illustrates a method according to an embodiment. In FIG. 1, metadata translation engine 110, including a translation layer (also called an execution layer) and service layer, is used to transparently translate metadata as datafiles are replicated from a source system to a target system. In this example, the source system is an enterprise NAS file system 100 with a directory structure of files. Associated with these files is metadata 101 (e.g., date, time, size, type, owner, when last backed up, compression and access, rules, etc). In this example, the target system can include cloud base file systems 120 or cloud based object systems 121. Of course it should be appreciated that the source and targets can be reversed.

The metadata translation engine communicates with the NAS 100 and the cloud base file systems 120 or cloud based object systems 121 either via direct connection or via internet 105.

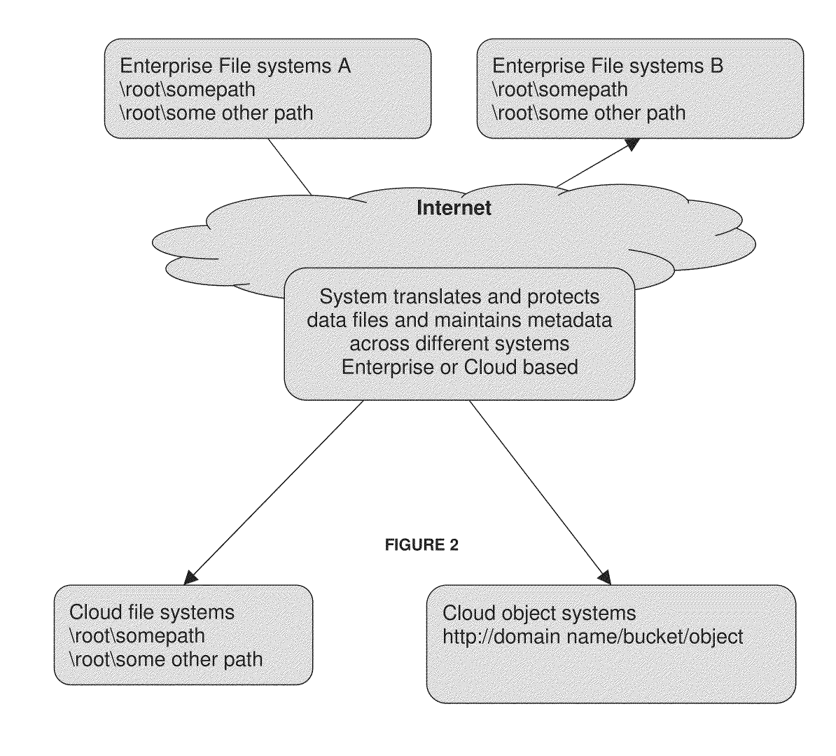

FIG. 2 schematically illustrates that such a system and method can be extended to include a plurality of enterprise file systems, which may be interconnected via the internet, which is also used to access the cloud based storage systems. The system translates and protects data files across the different storage systems, while maintaining the metadata across the different systems, which can be enterprise and/or cloud based.

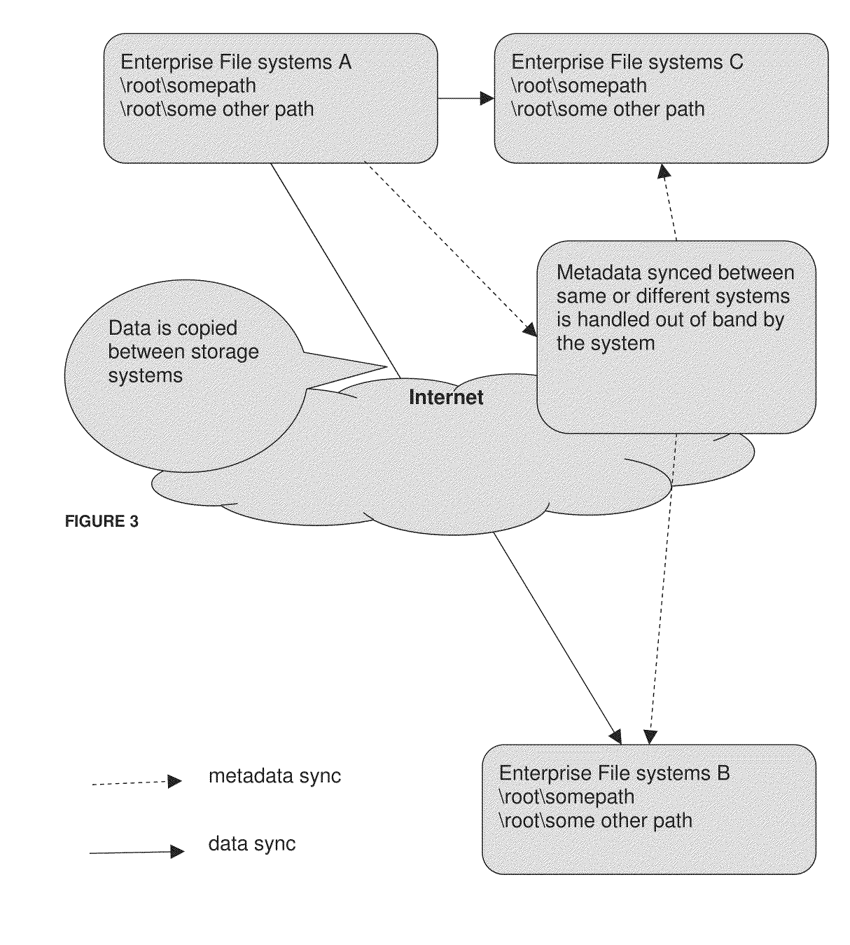

FIG. 3 schematically illustrates that the system for translating the metadata need not reside within the datapath of the data being replicated. Specifically, Data is copied between storage systems using a datasynch path (shown in solid line). However, the system for synchronizing the metadata can be handled out of band of the data utilizing a different path (shown in dotted line). Accordingly, it is noted that system is capable of operating on the metadata of the diverse storage systems without being in the data path between work stations or computers that are operating read and write operations against the data.

### System Overview

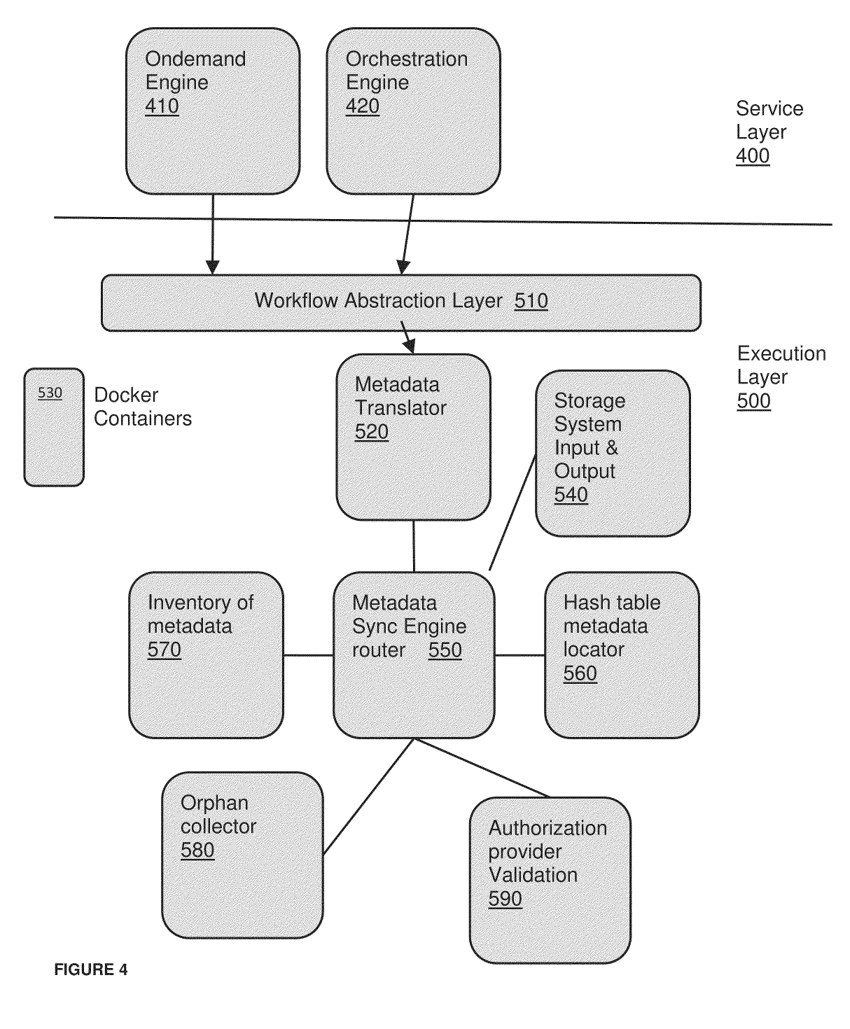

An example of one embodiment of the system functionality can be seen in FIG. 4.

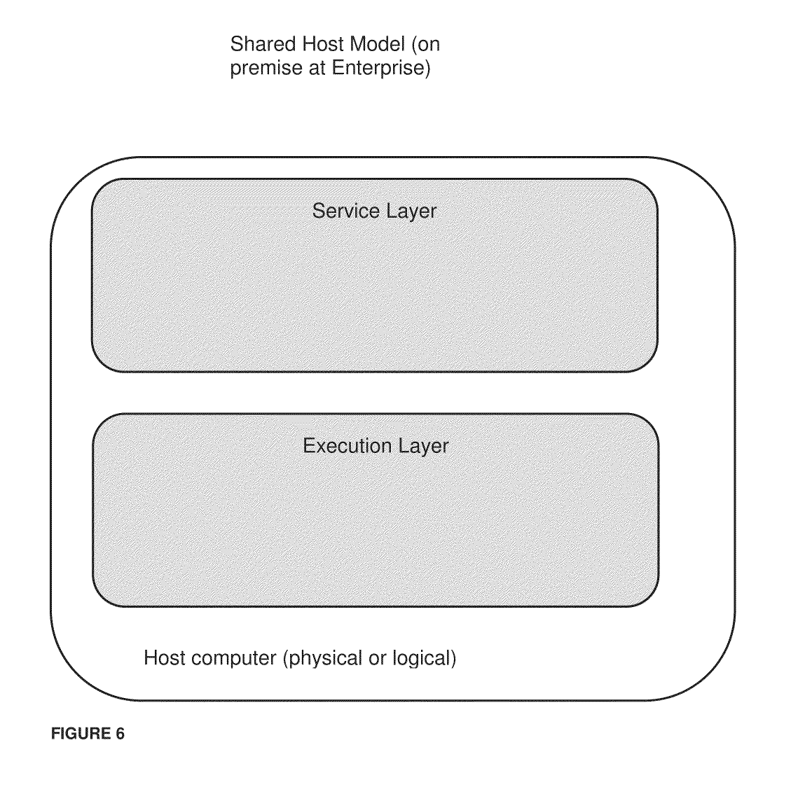

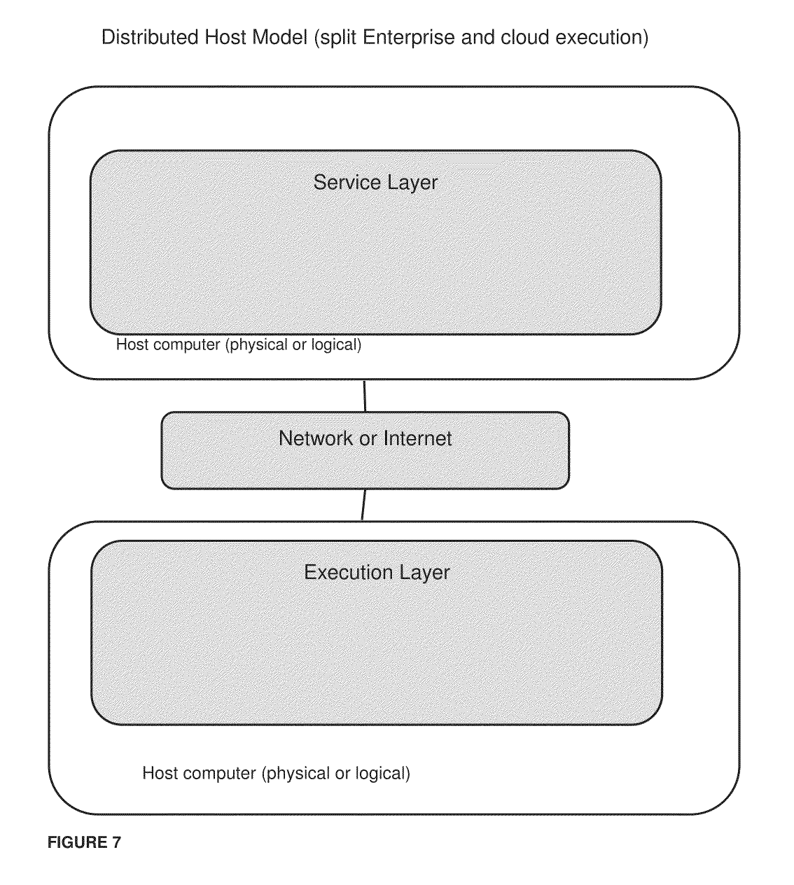

In one embodiment, the system has two layers that are broken down further into more functional areas. The service layer 400 is responsible for receiving requests, whereas the execution layer 500 processes the request. These two major layers can reside on one computer and each layer can share a central CPU, memory and disk as can be seen in FIG. 6 or alternatively these two layers can be separated by a network connection as can be seen in FIG. 7, as will be readily appreciated by the skilled person.

In at least one embodiment, the On-demand Engine 410 of the service layer 400 responds to a file action in the system that requires immediate real-time processing. This layer can have an API (Application Program Interface) and typically requires no user interface as it is contemplated for machine-to-machine requests and communications.

In at least one embodiment, the Orchestration Engine 420 of the service layer 400 is responsible for non-real-time work flow that assumes a batch or human interface is making a request that requires process. This layer can use API interfaces as a User Interface and feedback and error reporting.

The Service Layer can be abstracted using API's or, alternatively, messaging bus implementations between the Execution Layer and Service Layer. This is done for security and also for the ability to change the technology and implementation of each layer independently. It is contemplated that the two layers can share a computer or alternatively can be distributed between more than one computer as will be readily appreciated by the skilled person.

Each of the Service Layer and the Execution Layer can be functional and stateless, to allow the use of compute Docker or container technology as required by the particular end user application. This implementation can allow each function to be scaled independently with CPU, Memory, Disk and network-based on Docker deployment clusters 530 that have just enough operating system dependencies for the software to run. This allows each functional layer to be versioned for deploying each functional block on shared or distributed dockers to update or add features to each functional block.

The run time solution is designed to allow running in Docker containers 530 (Docker containers wrap up a piece of software in a complete file system that contains everything it needs to run: code, runtime, system tools, system libraries—anything you can install on a server). This guarantees that it will always run the same, regardless of the environment it is running in. The software can leverage Docker POD's which represents a group of containers used for controlling scaling of the software. POD's also supports failures and restart across physical hosts.

The docker functional mapping also enables scaling for capacity and high availability of a functional block allowing the docker pod failure and redeployment to be automated and allowing the functional block to be started or migrated to another docker pod. This is shown in

FIG. 4 indicating which functions are containers running within a Pod. This implementation is based on Kubernetes deployment model as will be readily appreciated by the skilled person.

The implementation allows for single host or alternatively distributed web scale deployments without modifications as will be readily appreciated by the skilled person.

### Service Layer On-Demand Engine 410

This functionality allows for machine-to-machine requests, the API defines request to move data from one source to target location. The source and target location can be the same storage platform, different platforms with the same metadata requirements or, alternatively, different metadata requirements as required by the end user application.

In at least one embodiment, it is contemplated that the requisite machine does not need to know about the differences in the metadata.

Metadata attributes that can be maintained throughout the system include, but are not limited to, the following list: file type (binary, text, image, compressed, encrypted, well known file type,) access abilities (read, write, write with locking, partial locking (the ability to lock a portion of the file), access permissions (read, write, execute, list, create, delete, update, append, mark read-only, lock, archive), share permissions to users, computers, applications, network names or share or export and protocol allow lists (for example, SMB, NFS, buckets, S3, Atmos, Vipr, Google storage bucket, among other protocol allow lists), among any other data attributes that will be readily contemplated by the skilled person.

It is contemplated that requests can be made over the API based on the operation requested, which can be for example, access, change metadata, replicate the data, make copies of the data, snapshot the data, cache the data, distribute the data, among any other requests that will be readily appreciated by the skilled person.

### Service Layer Orchestration Engine 420

It is contemplated that this layer can assume that a user interface is a functional display such as an interface to the API to allow a human to make the same API requests but assumes a pre-determined workflow of capabilities that can be done from the User interface.

It is contemplated that the requests can include, but are not limited to, web GUI feedback requests, progress requests, and monitoring of the workflow requests.

In some embodiments, it is contemplated that this layer is multi-user interface capable of supporting many users at the same time making requests of the system, among other arrangements that will be readily appreciated by the skilled person.

### Execution Layer-Workflow Abstraction Layer 510

It is contemplated that Layer Workflow Abstraction Layer 510 is responsible for receiving requests from the service layer modules and routing those requests to the correct functional block to begin a workflow.

It is also contemplated that the workflow abstraction layer can act as a request, routing a status feedback layer to the layer above and it also can provide security and assessment of the request from the layer above before processing.

It is also contemplated that this layer orchestrates requests between the modules as required to complete a workflow and return a response to the service layer.

### Execution Layer-Metadata Translator 520

In at least one embodiment it is contemplated that the metadata translator module 520 can translate metadata as described above between source and target systems.

It is contemplated that the translation described above attempts to make the requested metadata the same regardless of the format of the source system and target system and attempts to match the target system that best suits the requested functions.

In some embodiments, the business rules can determine the best location for the data based on the best match of the metadata capabilities of the configured targets in the system, or, alternatively availability of a target system to satisfy the request, as will be readily appreciated by the skilled person.

In some embodiments, it is contemplated that no provision for capacity is done within the system and assumes all source systems and target systems have a means to grow capacity without requesting it specifically, which is often now common on file-based systems as will be contemplated by the skilled person.

If a request fails due to insufficient resources to store data or, alternatively the request fails due to artificially placed limits such as space quota policies, the failure can simply be returned back to the service layer as a failure.

### Execution Layer-Metadata Inventory Module 570

It is contemplated that the Metadata Inventory module 570 can locate all metadata in the system using discovery functions on source and target storage systems configured in the system. Further, this system module can assume on startup the source system and target systems are configured and the discovery functions identify the existing metadata within each system.

It is contemplated that this system module identifies the capabilities of metadata supported by the source system or destination storage system. The information related to capabilities can also be maintained and updated with interval based scans of the existing systems or new ones added to the system.

It is also contemplated that this module can operate as a lookup or database of capabilities available in the system. Further, it is contemplated that this information can be made available to any other functional module in the execution layer as will be readily understood by the skilled person.

### Execution Layer-Metadata Hash Table 560

In at least one embodiment that this layer can operate as a fast lookup of all metadata attached to data that was processed through the system. In at least one embodiment, it is contemplated that metadata that was previously set is not added to this lookup function and rather in some embodiments only data processed via the system is tracked.

It is contemplated that this hash table requires that all metadata location and copies of data that are added, deleted or modified in the system can be tracked and stored in a manner that provides very fast lookup. Therefore, location of the appropriate metadata can be determined quickly for service layer requests acting on metadata and storage within that system.

In some embodiments, it is contemplated that this function has the largest storage requirement and speed requirement for processing real-time requests and, in some embodiments, requires persistency and copies of the hash table provided in memory.

As will be readily appreciated by the skilled person, the hash table is using a well-known method to index and reduce the CPU clock cycles to sort through a large volume of information and return a result.

In some embodiments it is contemplated that this module will use scaling of nodes for both storage and to compute capacity to grow the size of the hash table as the volume of metadata tracked requires scaling of the system.

### Execution Layer-Orphan Collector 580

It is contemplated that in at least one embodiment the Orphan collector module 580 can work off-line to review accuracy of the hash table indices and can act as a service layer function to make requests to verify the metadata results that are expected to succeed.

Further, this module can also perform an audit task or function that can perform validation post workflow to verify that the result returned is accurate and metadata actions are consistent within the system and the storage layers that provide the storage services.

It is contemplated that this module can attempt to correct any orphan metadata in the system as a cleaning process. Further, in some embodiments this module can attempt to validate workflows post execution and raise errors in the system. Finally, it is contemplated that this module can log all of the information it processes to assist in debugging the systems errors or failures.

### Execution Layer-Metadata Sync Engine 550

In some embodiments, it is contemplated that the Metadata Sync Engine module 550 is central to all modules and can route requests as required for processing between modules.

In at least one embodiment, the business logic and state machines for metadata operations reside in this module, which is configured to route requests between modules of the execution layer, processes error conditions, and performs data validation on requests between modules. Further, all requests can flow through this module, which will in turn use the other modules as required to complete atomic transactions against metadata.

It is also contemplated that this module can rollback any uncompleted multi-step requests. In some embodiments, it is also contemplated that the business rules on roll back and combinations and permutations of various source to destination storage systems are maintained in this module.

In some embodiments, it is contemplated that this module will can scale to increase processing. In such cases, this scaling will use either containers within a POD or a dedicated pod for this particular function.

In some embodiments, this module can send all its source or target API commands to the input and output storage modules to offload direction interaction with storage systems that may have various latency response times.

### Execution Layer-Input and Output Storage 540

In at least one embodiment the Input and Output Storage module 540 includes a source interface for accessing a first type of data stored in a source system and a target interface for accessing a second type of data stored in a target system. This module can thus for example, read data stored in a source system, which for example can be a NAS file system, and copy the data to a target system, which for example can be cloud based object system, or vice-a-versa.

In at least one embodiment, this module is responsible for storage system specific API calls that can manipulate metadata. It is contemplated that this module can receive requests from any other module to request and return data.

In at least one embodiment, this layer scales independently of the other module using containers to scale the processing. Further, this module can be updated with container tags to version control the support or direct requests to a subset of the VM's (virtual machines) in the container that handle a particular version of an API required to interact with a storage system.

Further, this capability can allow multiple versions of an API to exist for the same source or target storage system and not require changes in business logic or other modules by using container tags when requests are made within the system.

### Execution Layer-Authorization Validation 590

It is contemplated that the authorization validation module 590 can verify a request that is authorized against the metadata by issuing authorization requests for metadata and caching or using session data or authentication cookies as implemented in the various storage systems configured in the system.

In at least one embodiment this authentication can be centralized for security reasons and the storage input and output module makes use of this to get authorization credentials that need to carry out API calls to storage systems. In some embodiments, authorization information can be cached to reduce redundant authorization requests for each transaction.

In at least one embodiment, a container typically can comprise multiple VM's within a Pod and act as one larger computer system to outside systems. It is contemplated that this can allows the cluster to authorize request for all modules and only appear as single host making requests for authorization, greatly simplifying authorization functions in a large scale system.

As will be appreciated by the skilled person, authorization adds significant delay in millisecond response times and as such in at least one embodiment this module can accordingly reduce that time by caching and centralizing this function for all functional modules.

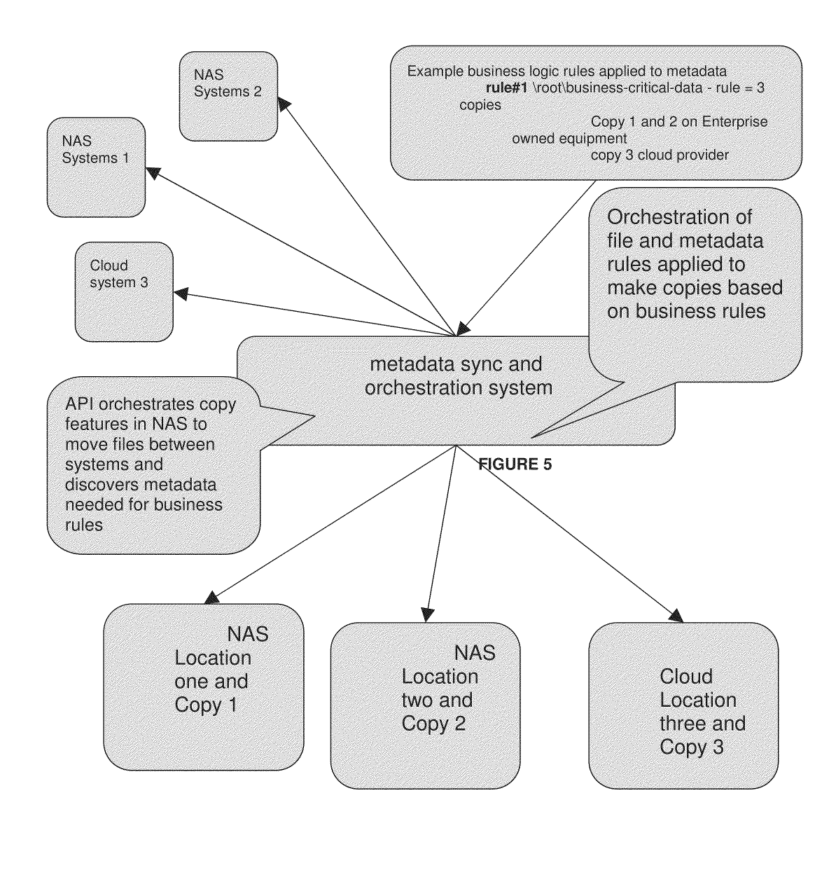

FIG. 5 schematically illustrates that the system can replicate data according to business rules and translates the metadata as data is replicated onto a plurality of storage systems. For example, consider a business rule which replicates mission critical data in three distinct locations, either for geographically dispersed systems, for disaster recover, or both. In this example two copies of data are maintained in two different NAS systems, while a third copy of the data is maintained in a cloud location. In this case APIs within the metadata synch system orchestrates copy file features in NAS array example sync between clusters features to move files between systems and discovers metadata needed for business rules. Orchestration of file and metadata rules applies to make copies of the file based on business rules, which means storing the business rules against the metadata that is attached the copies of the data. As is common in distributed file solutions, this allows finding the closest copy of data by scanning copies of the data using the metadata to locate the geographically closest copy of the data. This would be achieved using the metadata and location and copies lookup.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. A system comprising:
an execution layer including:
a source interface for accessing a first type of data stored in a source system;
a target interface for accessing a second type of data stored in a target system; and
a metadata translator for translating metadata as data is replicated from the source system to the target system.

2. The system as claimed in claim 1 further comprising a service layer for processing requests for accessing data.

3. The system as claimed in claim 2 wherein said service layer comprises:
an on-demand engine for responding to a file action in the system that requires immediate real-time processing; and
an Orchestration Engine service layer configured to process non-real-time work flow requests.

4. The system as claimed in claim 2 wherein the execution layer further comprises a workflow abstraction layer configured to orchestrate requests between modules of the execution layer and return a response to the service layer.

5. The system as claimed in claim 2 wherein the execution layer further comprises a metadata inventory module configured to locate metadata in the system using discovery functions on the source and target storage systems.

6. The system as claimed in claim 5 wherein the execution layer further comprises a metadata hash table for fast lookup of metadata attached to data that was processed through the system.

7. The system as claimed in claim 6 wherein the execution layer further comprises an orphan collector module configured to review accuracy of the hash table indices.

8. The system as claimed in claim 5 wherein the execution layer further comprises a metadata synch engine module configured to route requests between modules of the execution layer, processes error conditions, and performs data validation on requests between modules.

9. The system as claimed in claim 8 wherein the execution layer further comprises an authorization validation module configured to verify a request is authorized against the metadata.

10. The system as claimed in claim 2 wherein both the execution layer and the service layer are executed on a single host system.

11. The system as claimed in claim 2 wherein the service layer is executed on an enterprise host remote from a second host system which executes the execution layer.

12. A method of replicating data file between a source system and target system comprising;
processing a request to replicate the data;
accessing both the data file and metadata associated with the file from the source system;
translating the metadata to a translated form suitable for the target system; and
writing the file to the target system and storing the translated metadata.

13. The method as claimed in claim 12 wherein the source system and target system are geographically separated.

14. The method as claimed in claim 12 wherein the source system and target system utilize dissimilar storage systems.

15. The method as claimed in claim 14 wherein the translating maintains security of the data across the dissimilar storage systems.

16. The method as claimed in claim 14 wherein the source system is an NAS system and the target system is a cloud based object system.

17. The method as claimed in claim 14 wherein the source system is a cloud based object system and the target system is an NAS system.

18. The method as claimed in claim 14 further comprising discovering the metadata and business rules associated with the data.
